(19) United States
(12) Patent Application Publication
(10) Pub. No.: US 2008/0270913 A1
(43) Pub. Date: Oct. 30, 2008

(54) Methods, Media, and Devices for Providing a Package of Assets

(76) Inventors: Howard Singer, Morganville, NJ (US); Gregory Schwartz, New York, NY (US); George Lydecker, Burbank, CA (US); George White, New Rochelle, NY (US)

Correspondence Address: Byrne Poh LLP, 11 Broadway, Ste 865, New York, NY, 10004, US

(21) Appl. No.: 11/923,368

(22) Filed: Oct. 24, 2007

Related U.S. Application Data
(60) Provisional application No. 60/926,608, filed on Apr. 26, 2007.

(51) Int. Cl. G06F 15/16; G06F 3/048

(52) U.S. Cl. 715/748; 709/217

(57) ABSTRACT

Methods, media, and devices for providing a package of assets are provided. In some embodiments, methods of distributing a package of assets to a portable device are provided, the methods comprising: identifying the portable device; identifying an asset that correspond to the portable device and the package of assets; and transferring the asset and a definition of assets that corresponds to the package of assets to the portable device. In some embodiments, methods of presenting a package of assets on a portable device are provided, the methods comprising: providing information for identifying the portable device; receiving an asset and a definition of assets, wherein the asset corresponds to the portable device; and presenting the asset according to the definition of assets.

### CROSS-REFERENCE TO RELATED APPLICATIONS

This application claims the benefit of U.S. Provisional Patent Application No. 60/926,608, filed Apr. 26, 2007, which is hereby incorporated by reference herein in its entirety.

### FIELD OF TECHNOLOGY

The disclosed subject matter relates to methods, media, and devices for providing a package of assets on a portable device.

### BACKGROUND

Portable devices, such as mobile telephones, pocket computers, personal digital assistants, etc., have evolved significantly in recent years in their ability to present multimedia content to users. For example, many mobile telephones are able to play music (referred to commonly as “ringtones” or “mastertones”) instead of a traditional “ring” to alert a user to an incoming call. As another example, many portable devices can take photographs and movies, as well as present photographs, and other images, as well as movies.

Providers of multimedia-rich content, such as musical artists, have a wide following among the public and provide a wide array of content that is sought by the public. For example, a musical artist may produce songs, music videos, pictures, lyrics, drawings, news, and a vide variety of other content.

However, accessing content from such providers can be difficult for an ordinary user. For example, music may need to be obtained from one source, images from another, news from yet another, and so on.

### SUMMARY

Methods, media, and devices for providing a package of assets are provided. In some embodiments, methods of distributing a package of assets to a portable device are provided, the methods comprising: identifying the portable device; identifying an asset that correspond to the portable device and the package of assets; and transferring the asset and a definition of assets that corresponds to the package of assets to the portable device.

In some embodiments, methods of presenting a package of assets on a portable device are provided, the methods comprising: providing information for identifying the portable device; receiving an asset and a definition of assets, wherein the asset corresponds to the portable device; and presenting the asset according to the definition of assets.

In some embodiments, methods of presenting a package of assets on a computer are provided, the methods comprising: receiving from a portable device at the computer the package of assets including a definition of assets; modifying the package of assets to correspond to the computer; and presenting an asset indicated in the definition of assets.

In some embodiments, portable devices are provided, comprising: an interface; and a processor coupled to the interface that: provides information to the interface for identifying the portable device; receives an asset and a definition of assets, wherein the asset corresponds to the portable device; and causes the asset to be presented according to the definition of assets.

In some embodiments, computer-readable media are provided that contain computer-executable instructions that, when executed by a processor, cause the processor to perform a method for presenting a package of assets on a computer, wherein the method comprises: receiving from a portable device at the computer the package of assets including a definition of assets; modifying the package of assets to correspond to the computer; and presenting an asset indicated in the definition of assets.

### BRIEF DESCRIPTION OF THE DRAWINGS

FIGS. 1A and 1B are illustrations of tables that may be used to determine what assets of a package of assets may be used with different classes of portable devices in accordance with some embodiments.

FIG. 2 is an illustration of a table that may be used to show the relationship between versions of software, portable devices, and portable device classes in accordance with some embodiments.

FIGS. 3A and 3B are illustrations of data structures that may be used to store copies of assets in accordance with some embodiments.

FIG. 4 is an illustration of a file system interface for selecting a package of assets in accordance with some embodiments.

FIG. 5 is an illustration of the file system interface of FIG. 4 showing an album cover in accordance with some embodiments.

FIG. 6 is an illustration of a main menu in accordance with some embodiments.

FIG. 7 is an illustration of a media player in accordance with some embodiments.

FIG. 8 is an illustration of a media player being used to select a package of assets in accordance with some embodiments.

FIG. 9 is an illustration of an animated sequence in accordance with some embodiments.

FIG. 10 is an illustration of a template for a main menu in accordance with some embodiments.

FIG. 11 is an illustration of a mastertones template and an example application of that template in accordance with some embodiments.

FIG. 12 is an illustration of a wallpaper template and an example application of that template in accordance with some embodiments.

FIG. 13 is an illustration of a video ringers template and an example application of that template in accordance with some embodiments.

FIG. 14 is an illustration of a lyrics template in accordance with some embodiments.

FIG. 15 is an illustration of a mobile sign-up template in accordance with some embodiments.

FIG. 16 is an illustration of behind-the-scenes interface template in accordance with some embodiments.

FIG. 17 is an illustration of a template for playing a track in accordance with some embodiments.

FIG. 18 is a block diagram of a system in accordance with some embodiments.

### DETAILED DESCRIPTION

The following description includes many specific details. The inclusion of such details is for the purpose of illustration only and should not be understood to limit the invention. Moreover, certain features, which are well known in the art, are not described in detail in order to avoid complication of the subject matter of the present invention. In addition, it will be understood that features in one embodiment may be combined with features in other embodiments of the invention.

Methods, media, and devices for providing a package of assets (which may be referred to as an “EP”) on a portable device are provided. Examples of assets include video clips, audio clips (e.g., music), pictures, animations, ringtones, lyrics, icons (e.g., Instant Messenger Buddy Icons), text, avatars, wallpapers, screensavers, games, remix applications (e.g., ring-tone editors, re-mixable and/or multi-track audio files that allow a user to create custom mixes of audio (e.g., U-MYX files), etc.), skins, RSS feeds, XML documents, and any other suitable text-, image-, video-, and/or audio-based content, and/or any other personalization products. In some embodiments, two different assets may contain the same content (e.g., a song, a video, an image, etc.) but in different formats (e.g., one digitized at a sampling rate of 64 kbps and the other at 128 kbps, one in a .WAV file format and the other in a .MP3 file format, etc.). That is, two different assets may be different versions of the same content. Examples of portable devices that can be used to deliver a package of assets include mobile phones, portable music and/or video players, portable game consoles, personal digital assistants (PDAs), portable navigation units, pocket computers, laptop computers, smart phones, portable email devices (e.g., a RIM Blackberry), automobile navigation system, automobile entertainment system, and any other suitable portable electronic devices for providing text-, image-, video-, and/or audio-based content. A package of assets, in some embodiments, may include a variety of media types for a single artist or artistic group, a film or television program, and/or any other provider of content.

In some embodiments, in order to provide the appropriate multimedia assets to the portable device, mechanisms are provided for determining the class of portable device being used by the user and for creating the appropriate package of assets for that device. This package may include different components selected and configured (e.g., sized, encoded, etc.) for the class of device.

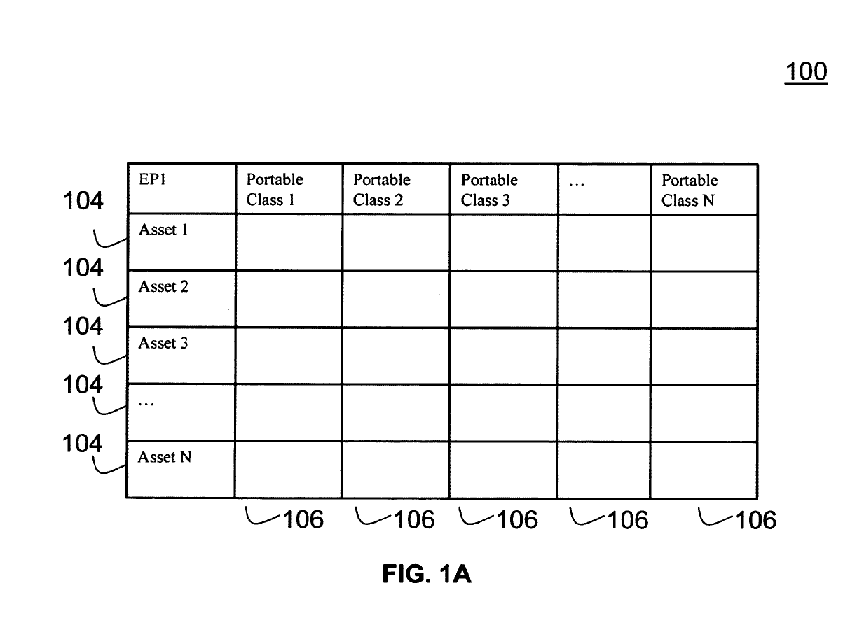

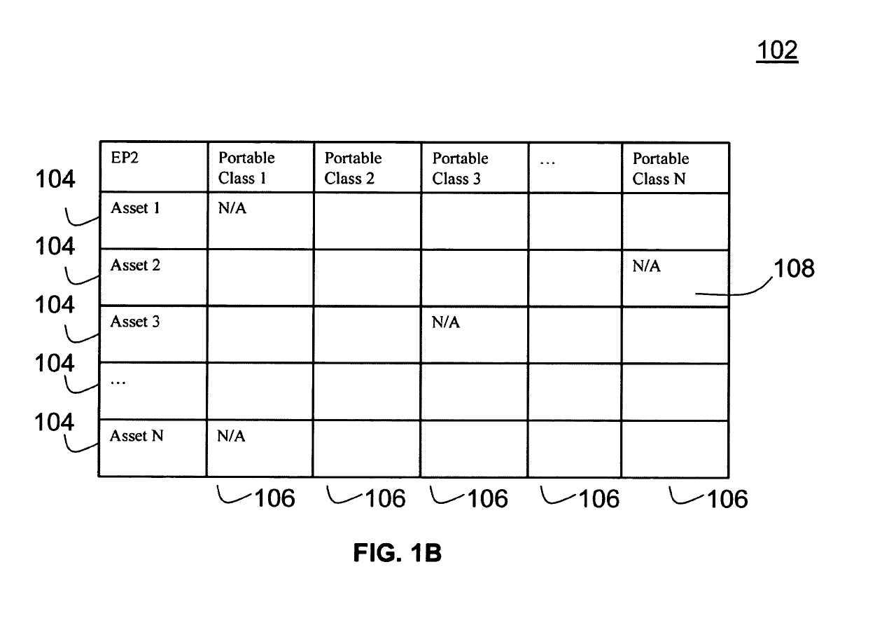

In some embodiments, two-dimensional data structures (e.g., tables—like a spreadsheet, for example) can be used to store the configuration options for each package of assets. For example, as illustrated in FIGS. 1A and 1B, a first configuration-option table 100 may be used to store the configuration options for a first package of assets (EP1) and a second configuration-option table 102 may be used to store the configuration options for a second package of assets (EP2).

The rows 104 in such tables may correspond to the possible assets (Asset 1, Asset 2, Asset 3, . . . , Asset N) that can be provided as part of a specific package of assets. As the possible assets change (e.g., because new ones become available or because existing ones are not popular), new rows may be added to the tables and/or old rows deleted. The columns 106 in such tables may correspond to the different classes of devices that can receive packages of assets (e.g., Portable Class 1, Portable Class 2, Portable Class 3, . . . , Portable Class N). A portable class may include multiple types of devices and/or multiple versions of the same software (e.g., operating system, application software, etc.) running on different devices. In some embodiments, a portable class may include only one device. As the possible portable classes change (e.g., because new classes are developed or old ones no longer used), new columns may be added to the tables and/or old columns deleted.

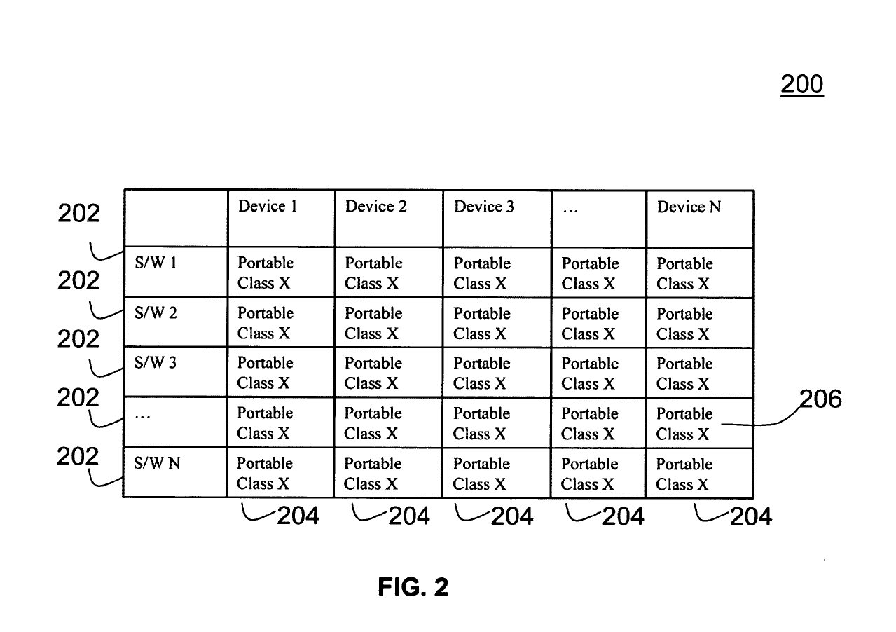

The relationship between portable classes, types of devices, and/or versions of software can be reflected in one or more portable-class tables 200 as shown in FIG. 2. As shown, each row 202 in the table of FIG. 2 may correspond to a particular version or piece of software and each column 204 may correspond to a particular type of device. The cell 206 at the intersection of a row and a column may reflect the portable class for that combination. As illustrated, each cell contains “Portable Class X” to reflect that the cell can contain any suitable class designation, and that each cell could have the same or a different class designation as one or more other cells. In some embodiments, a certain designation of portable class can be used to represent that a combination of software version and device type is invalid or unsupported.

Turning back to FIGS. 1A and 1B, an entry 108 at the intersection of a row and a column of the configuration-option table may be used to indicate whether the asset in the corresponding row is available for the particular portable class in the corresponding column. For example, a cell may be used to indicate that a particular asset is available (e.g., by containing an “A” (or any other suitable indicator)) or is unavailable (e.g., by containing an “N/A” (or any other suitable indicator)) on a particular portable device class. An asset may be unavailable, for example, because the device does not have suitable processing power to play a particular game defined by the asset. Alternatively to containing an “A” (or other indicator) to indicate that the asset is available, the cell may indicate the quality level appropriate for that asset for that device class. Such indications may aid in selecting assets for a portable device. For example, the quality for video content (and/or any other suitable characteristic) can be selected to correspond to the size and resolution of the display in the particular portable device class. As another example, the quality of audio content assets may be selected based upon the digital rights management (DRM) technology implemented in the portable device class (e.g., if the device class only has Open Mobile Appliance (OMA) standard 1.0 with forward lock, full tracks might only be delivered at a much reduced audio sampling level over other types of DRM technology).

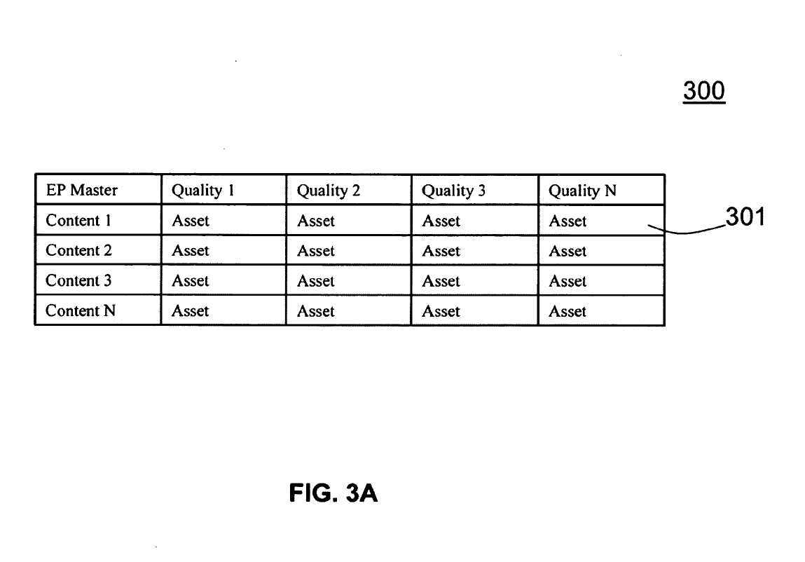

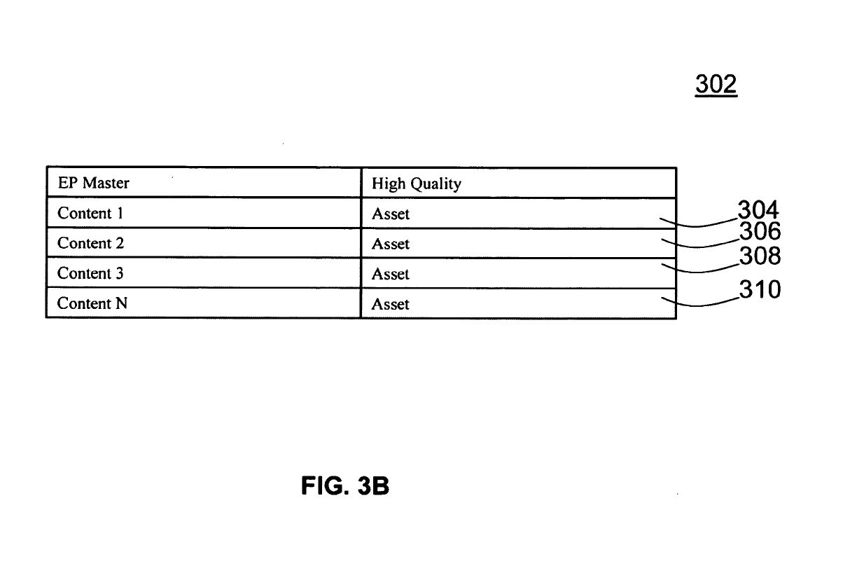

In some embodiments, a “master” version of each piece of content for a package of assets can be stored in any suitable storage mechanism. For example, as illustrated in FIG. 3A, copies 301 of different pieces of content at different qualities (e.g., different screen sizes/resolutions for video content, sampling levels for audio content, etc.) can be stored in a two-dimensional structure 300 for each package of assets.

Alternatively, as illustrated in FIG. 3B, as another example, for each piece of content, a single copy 304, 306, 308, or 310 of the piece of content at a relatively high level of quality can be stored in a one-dimensional structure 302 for each package of assets. At the time of the delivery, for example, the copy can then be encoded or trans-coded into the appropriate quality level for delivery as an asset, although this may impact performance and throughput for such an embodiment. As another example, certain encoding technologies that allow a piece of content to be stored at high quality using a scheme that makes it easy to “extract” the lower quality versions without the additional step of trans-coding may additionally or alternatively be used. The MPEG-SLS standard is an example of such a technique for audio.

A parameter that identifies the device class of a given device can be provided by the device to facilitate determining which assets can be delivered. Any suitable mechanism can be used to provide this parameter. For example, this device class parameter can be provided as a WAP environment variable in response to an automatic polling of the device by a server wirelessly coupled to the device. In some embodiments, the parameter can be provided without the user knowing that it is being provided. This parameter can be provided at the time that a request for a package of assets is made, prior to the request being made, or even after the request is made. When made before the time of a request, the parameter can be used to market the available assets to particular device classes.

Additionally or alternatively, parameters that define characteristics of a device can be used to determine which assets can be delivered and/or to define a class of devices (e.g., for a new device). Such characteristics may include screen size, supported codec(s), video resolution, audio sample rate, color palette, connectivity type (e.g., protocol, speed, etc.), fonts available, device location (e.g., in the United States, in the United Kingdom, etc.), image format (e.g., JPEG, bitmap, etc.), software type (e.g., version, language, brand, etc.), hardware type (e.g., processor capacity, available storage, etc.), and/or any other suitable characteristics. When defining a class of devices, tables, such as those illustrated in FIGS. 1A, 1B, and 2, may be modified to reflect the class of devices.

The packaging of assets can be done in advance and then delivered in response to a request for a package of assets by a device. The packaging can also be done in response to such a request for a package of assets by a device (e.g., in real-time as part of an order-fulfillment process).

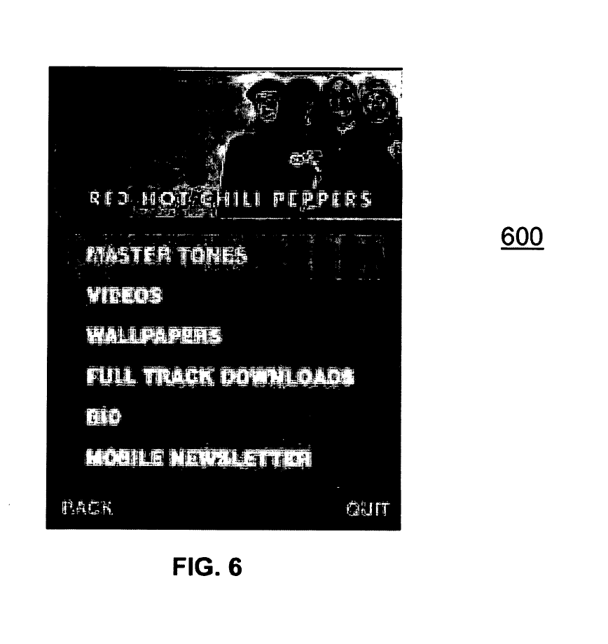

When a package of assets is transferred to a device, the package of assets may include, be accompanied by, or consist of a definition of assets in the package of assets. Any suitable mechanism can be used to provide the definition of assets. For example, a table can be used to list assets in a package of assets. As another example, a set of instructions (e.g., a script or program) can be used to define the assets. This definition may define what content is in the assets, how the various assets are presented to a user, how interaction between the assets occurs, whether the holder of the definition of assets has, one or more certain devices have, or one or more users have authorization to access the specified assets or content, etc. For example, a menu structure, user interfaces, and/or menu templates may be defined by the definition of assets for example as illustrated in FIGS. 6 and 9-17 below.

In accordance with some embodiments, a customized interface (e.g., a skin) for a particular device class may be automatically created based upon the assets that are available for that device class. In this way, a menu of choices with only those assets that are relevant for that bundle and that device class may be presented on the device.

In some embodiments, the user can personalize material once it is on his or her device. For example, certain assets (e.g., wallpapers, ringtones, avatars, etc.) can be assigned as being the default assets on the device by using one or more clicks in a menu or on a graphic or image representing the assets.

In some embodiments, the user can also substitute some assets in a package of assets with other assets. For example, if a package of assets includes certain ringtones, videos, music files, etc., the user can substitute those assets with other assets to create personalized packages of assets. As another example, the user may be able to add, supplement, or edit (e.g., by mixing the user's voice into a music-based ring-tone) assets to personalize the set of assets.

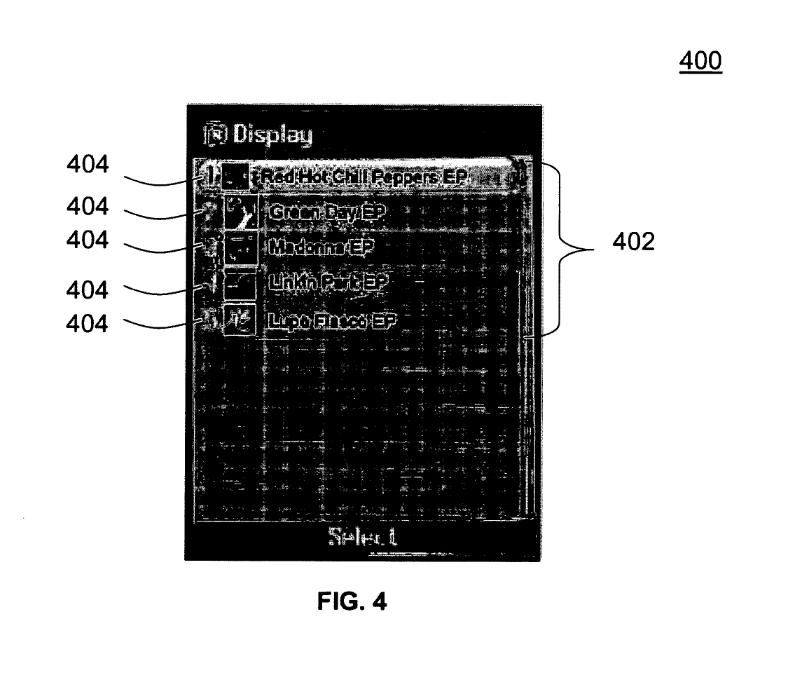

In some embodiments, a package of assets may be selected from a file system interface. The file system interface may offer, for example, a textual interface with graphical elements that allows a user to easily pick and choose a package of assets based on album artwork and/or basic animated thumbnails. An example of a file system interface 400 is illustrated in FIG. 4.

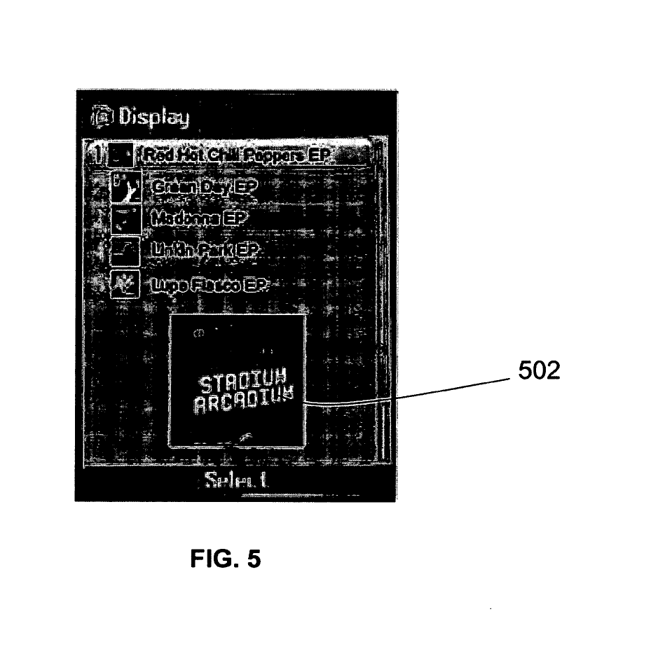

More particularly, the file system interface may allow a textual interface that allows the user to easily pick and choose packages of assets from a main deck 402. Album artwork 404 and/or other imagery may be included in this interface, for example, to give a visual preview of the package of assets. When a user chooses a package of assets, a screen may then be displayed which shows the album cover art 502 or a visual preview of the package of assets as shown in FIG. 5. The visual preview may be static or dynamic—e.g., it may include animations and/or video. For example, a visual preview may be presented with a combination of a video clip, an audio clip, animations, still menu options, etc. (e.g., as may be presented in a main menu of a digital video disk (DVD)). A menu 600 for the package of assets then may be presented, for example, as illustrated in FIG. 6. As can be seen, this menu may provide the user with options for performing different functions with the package of assets.

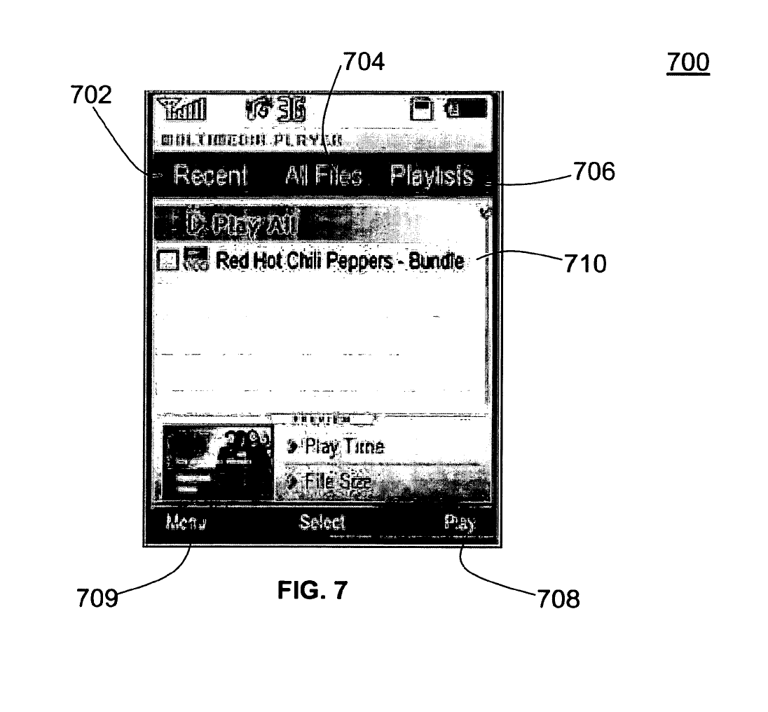

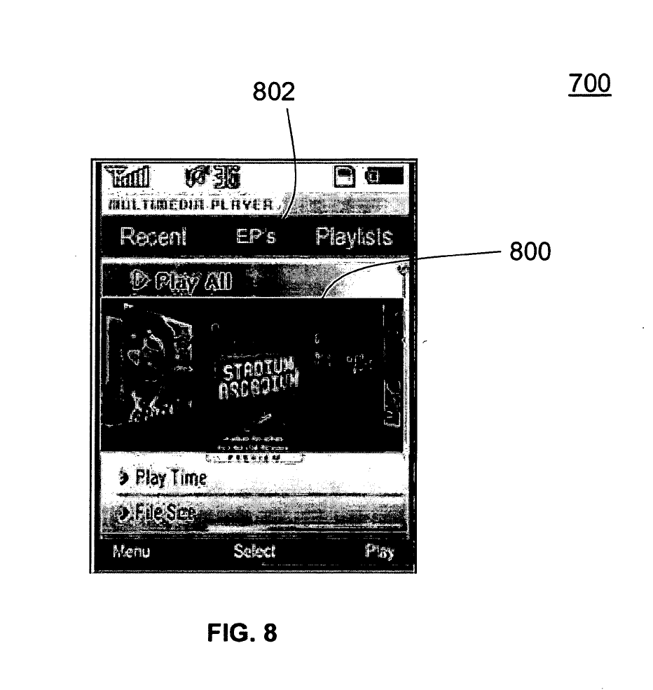

In some embodiments, a media player interface 700 may additionally or alternatively be used to access assets and/or select a package of assets as shown in FIGS. 7 and 8. Using this interface, in some embodiments, a user can view and select to play recently viewed assets, all assets, and/or playlists by selecting tabs 702, 704, and 706, respectively, and the user can also search by artist, track or package of assets (e.g., by selecting menu option 709 and selecting an appropriate menu choice (not shown) or by using any other suitable mechanism). In some embodiments, for example, a user can listen to audio from a package of assets while navigating through other portions of the package of assets (e.g., a user can listen to audio while viewing news and tour and/or other event dates without the audio being interrupted). For example, this may be done by selecting play option 708.

By selecting an “EP's” tab 802, the user may also see a set of packages of assets that are available to be accessed by the user. These packages of assets may be presented in any suitable arrangement. For example, as illustrated, each package of assets may appear as a record album 800 in a three-dimensional carousel of albums which may be scrolled and selected from by the user. These albums may be static or dynamic. After viewing and selecting an album, the user can then proceed to a main menu for the package of assets, as illustrated above in FIG. 6.

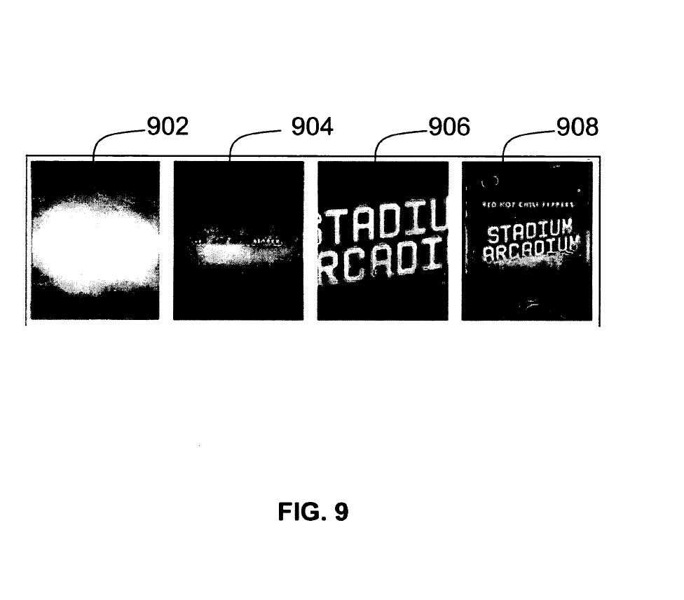

In some embodiments, upon selecting a package of assets (for example, before displaying the package of assets' main menu or when first loading the package of assets to the device), an animated sequence may be presented. For example, a sequence may include the screen snap-shots 902, 904, 906, and 908 shown in FIG. 9 (which could be presented in order from left to right). It should be apparent that many more intermediate images, or a video clip can be presented as part of this sequence. This animated sequence can be accompanied by music or an artist voice-over that is tied to the sequence.

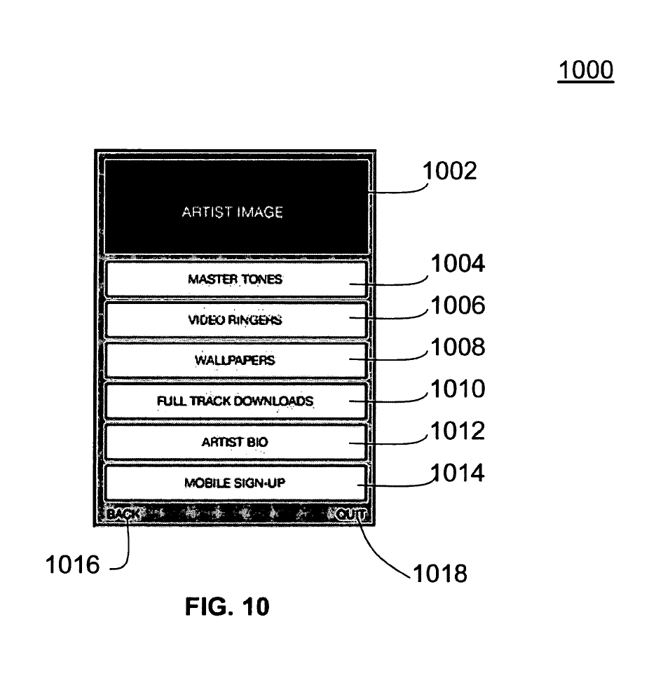

A template 1000 for the main menu, illustrated in FIG. 6, is shown in FIG. 10. As illustrated, this menu may include an artist image 1002 at the top and menu options that may include mastertones 1004, video ringers 1006, wallpapers 1008, full track downloads 1010, artist bios/lyrics 1012, and mobile sign-up/promotions 1014. By selecting any one of these options using a device's cursor control, for example, the user may be presented with the corresponding asset or a corresponding sub-menu or interface. The menu may also include options 1016 and 1018 for navigating to other menus (e.g., back and quit).

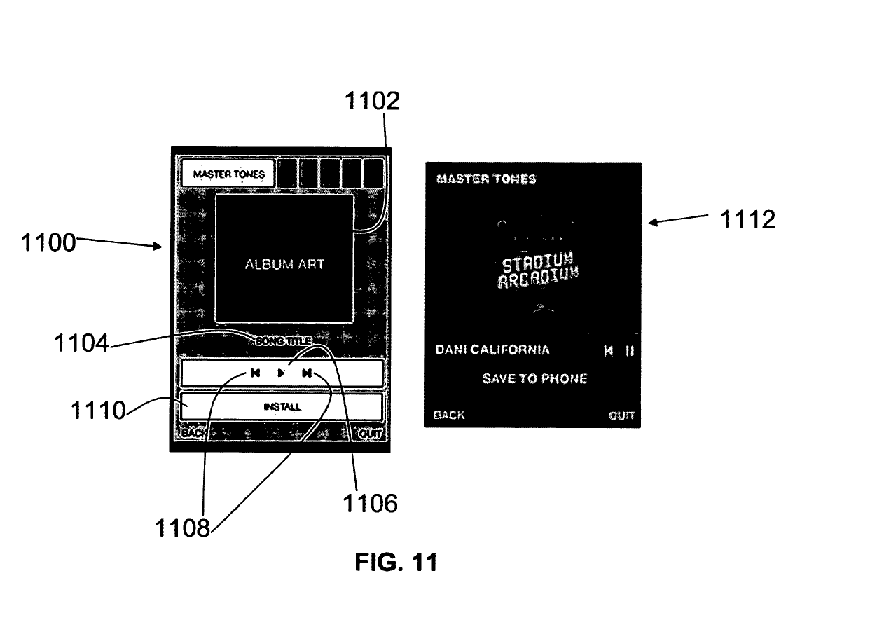

A sample template 1100 for a mastertones interface is shown in FIG. 11. As can be seen from the template, this interface can enable a user to see an album cover 1102, view a song title 1104, play a music clip 1106, skip to other clips 1108, and install the clip on the user's device 1110. This interface may also allow the user to purchase mastertones (e.g., music clips) and/or other forms of ringtones for voice call alerts, SMS message alerts, email alerts, voicemail alerts, alarm clock alerts and/or any other suitable portable device alerts. An application of template 1100 to a specific package of assets is illustrated as 1112.

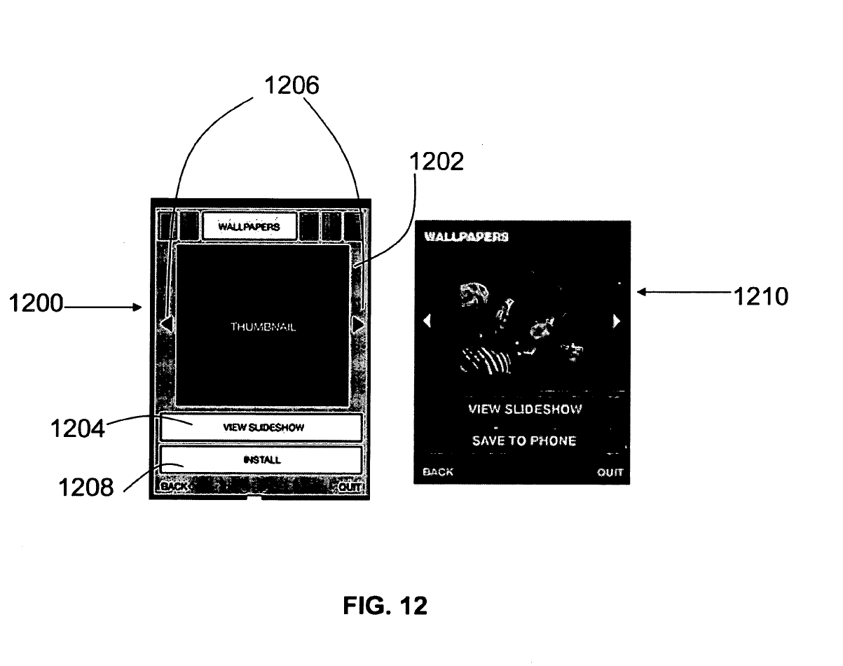

A sample template 1200 for a wallpaper interface is shown in FIG. 12. As can be seen from the template, this interface can enable a user to view a thumbnail 1202 of the wallpaper, view a slide show of wallpapers 1204, skip to other wallpapers 1206, and install a wallpaper on the user's device 1208. This interface may also enable the user to set the wallpaper as the device's wallpaper or as the device's screen saver, or show other wallpapers/mobile albums available for purchase. An application of template 1200 to a specific wallpaper is illustrated as 1210.

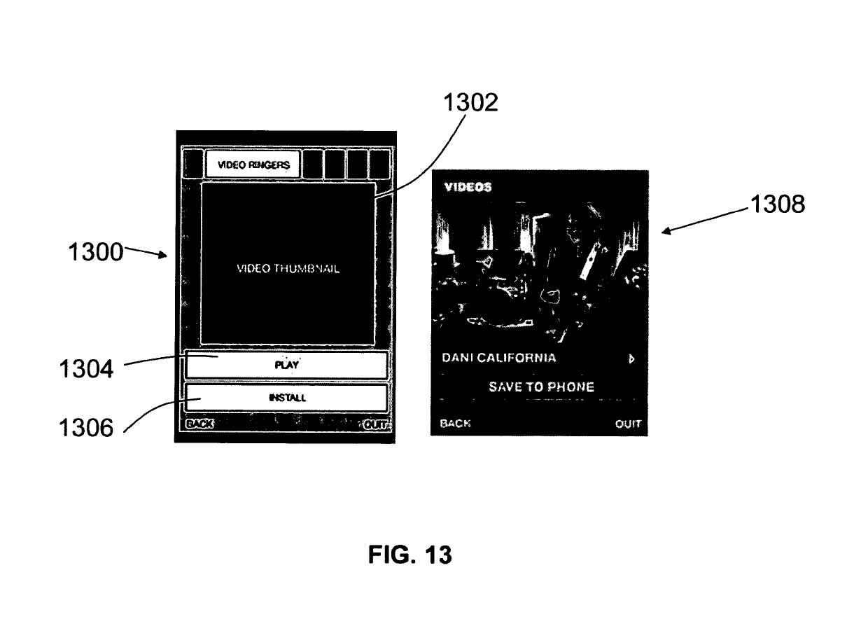

A sample template 1300 for a video ringers interface is shown in FIG. 13. As can be seen from the template, this interface can enable a user to view a video thumbnail 1302 of the video ringer, play the video ringer 1304, and install the video ringer 1306. This interface may also enable the user to set the video ringer as the device's screen saver, or post the video to the World Wide Web on an authorized or approved sharing platform (e.g., www.imeem.com or www.youtube.com) that complies with copyright holder authorization requirements, or show other video ringers available for purchase. An application of this template to a specific video ringer is illustrated as 1308.

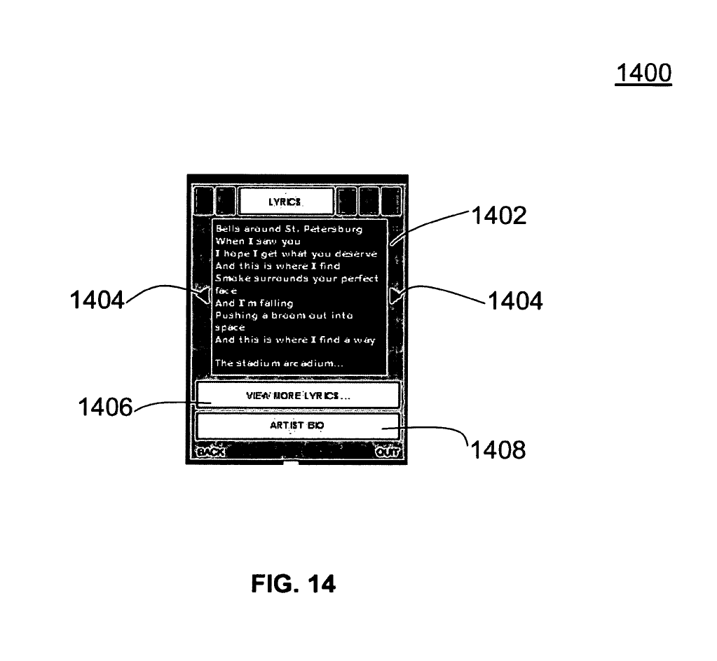

A sample template for a bios/lyrics interface 1400 is shown in FIG. 14. As can be seen from the template, this interface can enable a user to view lyrics 1402, skip to more lyrics 1404 and 1406, and view an artist bio 1408.

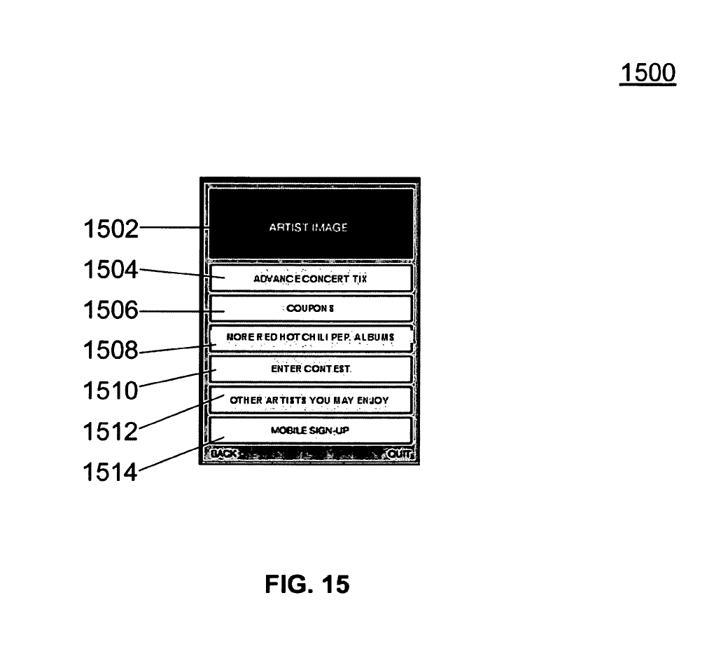

A sample template 1500 for a mobile sign-up/promotions interface is shown in FIG. 15. As can be seen from the template, this interface can enable a user to view an artist image 1502, order concert tickets 1504, get coupons 1506, see more albums by the same artist 1508, enter a contest 1510, learn about other artists that the user may enjoy (e.g., based on this current artist's style and/or the style of other artists select by the user) 1512, and perform a mobile sign-up (which is described in more detail below) 1514. This interface may also enable a user to buy other albums or make recommendations of other artists that may be interest to other users.

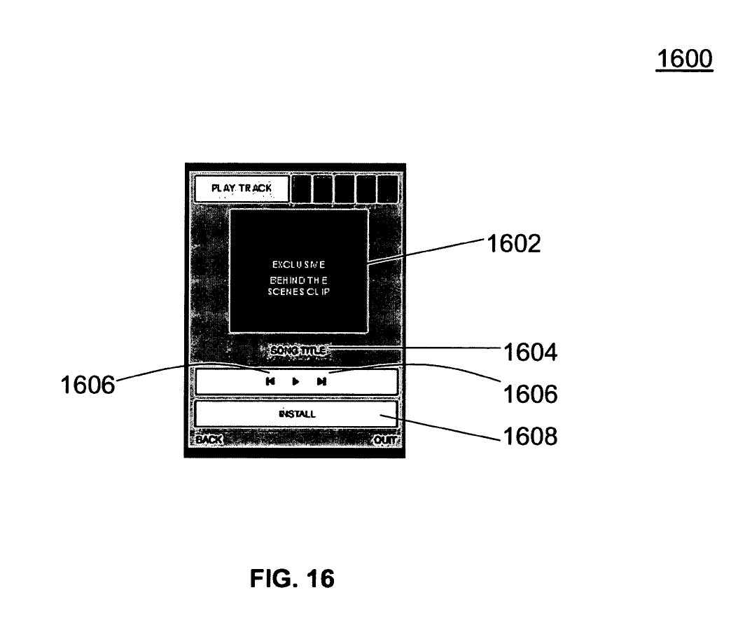

Although not shown in the template of FIG. 10, the main menu may also include an option to view behind-the-scenes clips. A sample template 1600 for a behind-the-scenes-clips interface is shown below in FIG. 16. As can be seen from the template, this interface can enable a user to view behind-the-scenes clips 1602, view a song title corresponding to the clip 1604, skip to other clips 1606, and install the clip 1608. This interface may also enable a user to see other types of video clips such as a “making-of” video or live footage, and/or allow the user to purchase additional content.

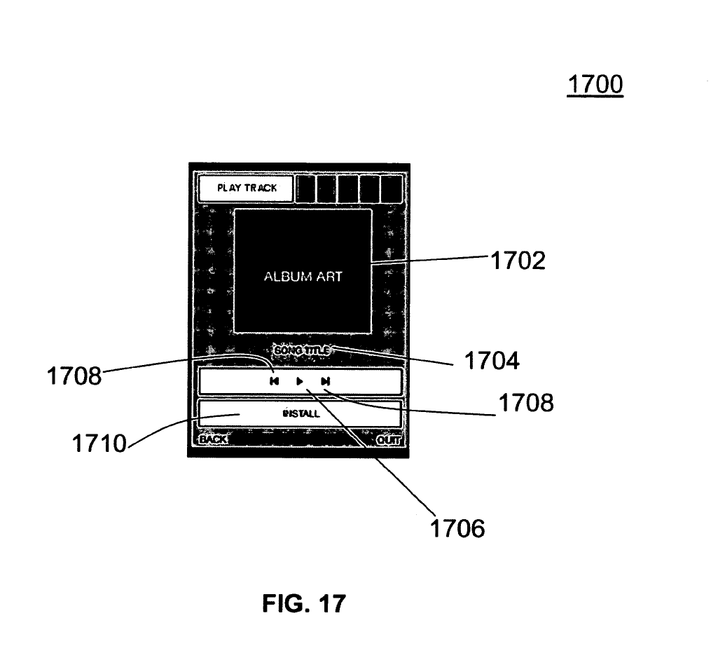

Although not shown in the template of FIG. 10, the main menu may also include an option to play a track. A template 1700 for such an interface is shown below in FIG. 17. As can be seen, this user interface may enable a user to view album art 1702, see the song title 1704, play the track 1706, skip to other tracks 1708, and install the track on the device 1710. This interface may also enable the user to purchase other tracks (e.g., other tracks on the same album, by the same artist, by similar artists, etc.).

As mentioned above in connection with FIG. 15, an interface in some embodiments may enable a user to perform a mobile sign-up. A mobile sign-up is when a user takes a subscription to additional content associated with a package of assets. For example, when a user performs a mobile sign-up, the user may automatically receive news, content, artist updates, community interaction (e.g., access to message boards, broadcast SMS messages, blogs, etc. of other subscribers), artist video conferences, and any other suitable content that is updated during the term of the subscription.

In some embodiments, a user may also receive new and/or substitute assets. For example, a user can receive a new audio asset (e.g., an audio clip), a new video asset (e.g., a video clip), or other new asset, such as updated news, updated tour and/or other event dates, etc. These assets can be presented in an integrated fashion with the other assets that are part of the package of assets. These assets can be updated so that each time a user launches a package of assets, new assets are presented.

In some embodiments, when performing a mobile sign-up, a user may be required to provide certain information and/or pay a subscription fee. For example, the information may include user name, address, phone number, email address, date of birth, and/or any other suitable personal information. This information may then be used (subject to any applicable laws or privacy policy) to better market to the user and other people in the user's demographic. As another example, the information may include suitable information to determine that the user has an authorized package of assets.

In some embodiments, the user may also be able to opt-in to certain forms of updated asset(s). For example, the user may elect to receive certain SMS messages, emails, voicemail messages, and any other suitable content as it is automatically updated and distributed for a desired artist.

In some embodiments, the assets, content, etc. provided in connection with the package of assets can be secured using any suitable technology. For example, in some embodiments, the assets can be protected using Digital Rights Management (DRM) techniques, such as encryption. As another example, in some embodiments, some assets can have watermarks applied, wherein the watermarks may be observable by a user or may be obfuscated.

By securing the assets in the package of assets, unauthorized copying or access to mobile sign-ups can be prevented, minimized, or discouraged. For example, by applying DRM to a package of assets, a user may be prevented from sharing a package of assets among multiple devices or users.

As another example, a watermark in the package of assets can be used to control access to mobile sign-up, and therefore may be used to discourage a user from sharing a package of assets that is otherwise unsecured. More particularly, a unique identification number from the watermark can be required when signing-up for the mobile sign-up and can be either manually entered by the user or automatically retrieved from the package of assets. In some embodiments, when a watermark, or an identification number therein, cannot be used to verify that a package of assets is authorized, a user seeking to sign-up for a mobile sign-up may be required to pay a fee or may be prevented from signing-up altogether.

In some embodiments, each identification number may only be valid for one mobile sign-up. Thus, if a first user of a package of assets shares the package of assets with a second user, the first user may risk that the second user may sign-up for the package of assets before the first user does and thereby prevent the first user from being able to use that identification number to sign-up.

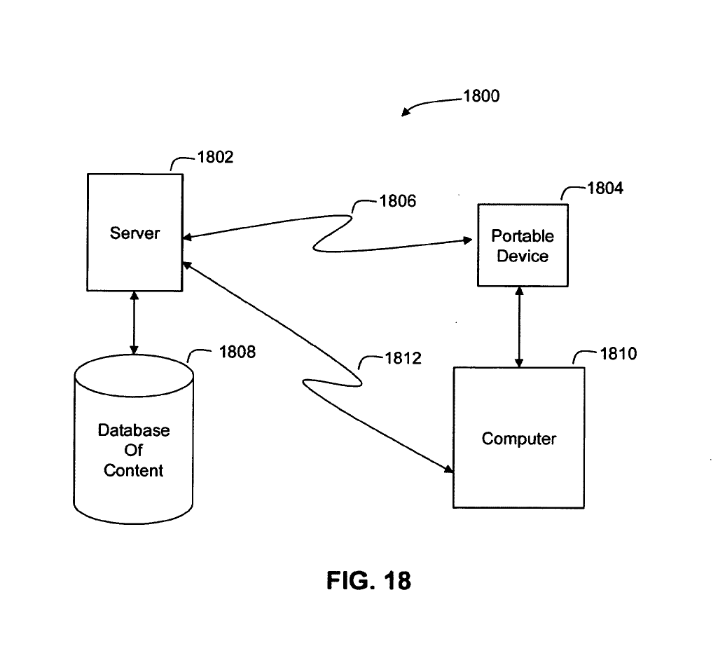

An example of a system architecture for providing a package of assets in accordance with some embodiments is shown in FIG. 18.

As illustrated, a system 1800 may include a server 1802 that is coupled to a portable device 1804 through a connection 1806. Server 1802 may be any suitable server, computer, data processing device, etc. for providing a package of assets to a portable device. Portable device 1804 may be any suitable device for presenting a package of assets as described above. Connection 1806 may be any suitable connection for coupling server 1802 and portable device 1804, may be a wired connection, a wireless connection, or a combination of the same, and may include any suitable communication network, such as the Internet, a local area network, a wide area network, a wireless network, a telephone network, a cable network, a satellite network, etc. Server 1802 may communicate with portable device 1804 using any suitable protocol, such as the wireless application protocol (WAP), TCP/IP, etc.

In some embodiments, server 1802 may store assets in a database of content 1808. Database 1808 may be any suitable device for storing assets, and may be a database, a disk drive, a data structure in memory, etc. Database 1808 may be part of or connected to server 1802.

In some embodiments, portable device 1804 can also be coupled to a computer 1810. The computer may be any suitable computing device including a personal computer, such as a desktop computer, a laptop computer, a tablet computer, a pen-based computer, etc., a personal digital assistant, a set-top box, a game console, a digital video recorder, a media center computer, a home automation computer, an appliance computer, etc. In some embodiments, server 1802 may also be coupled to computer 1810 through a connection 1812. Connection 1812 may be any suitable connection and may be similar to connection 1806.

Each of server 1802, portable device 1804, and computer 1810 can include one or more processors and one or more interfaces. The processor(s) in each can be any suitable processing devices including microprocessors, digital signal processors, controllers, etc., and may be the same or different within or between server 1802, portable device 1804, and computer 1810. The interface(s) in each can be any suitable interface and may use any suitable protocol. The interfaces can correspond to the type of connection(s) used by server 1802, portable device 1804, and computer 1810. For example, server 1802 and portable device 1804 can each include a wireless interface when connection 1806 is a wireless connection.

Portable device 1804 may be coupled to computer 1810 for various reasons including transferring (e.g., moving or copying) one or more pieces of content, assets, packages of assets, and/or definitions of assets from the portable device to the computer and for transferring one or more pieces of content, assets, packages of assets, and/or definitions of assets from the computer to the portable device. For example, a user may desire to transfer a definition of assets from the portable device to the computer so that the user can store one or more portions of a package of assets on the computer. This may be the case because the user wants to ultimately transfer the package of assets to another portable device. This also may be the case because the user wants to access the package of assets on the computer (e.g., to view or modify the package of assets).

When accessing a package of assets on the computer, the package of assets may appear in a similar manner to that shown and described in connection with FIGS. 6 and 9-17. Alternatively, the package of assets may appear differently to that shown in connection with FIGS. 6 and 9-17. This may be the case because the computer may have different presentation capabilities than the portable device from which the package was transferred. In such cases, for example, the package of assets may be modified for presentation on the computer. In some embodiments, this may be accomplished by loading different assets corresponding to one or more different classes of devices than the assets presented on the portable device. Such different assets for the package presented on the computer may include the same or different content than the assets for the same package on the portable device. These assets may be transferred from the portable device to the computer or may be obtained by the computer from the server or the database. How and what assets are presented on the computer may be controlled by the definition of assets. In some embodiments, the definition of assets may include instructions that can be executed by the computer. In some embodiments, the assets may be directly accessed by the computer without accessing the definition of assets.

As another example, the user may desire to transfer content from the computer to the portable device because access to the package of assets is available through the computer. This may be the case when connection 1806 is unavailable or too slow to be effective. This may also be the case when the user has obtained a package of assets that is for both the computer and the portable device, but has been first provided to the computer.

It is to be understood that the invention is not limited in its application to the details of construction and to the arrangements of the components set forth in the description above or illustrated in the drawings. The invention is capable of other embodiments and of being practiced and carried out in various ways. Also, it is to be understood that the phraseology and terminology employed herein are for the purpose of description and should not be regarded as limiting.

Although the present invention has been described and illustrated in the foregoing illustrative embodiments, it is understood that the present disclosure has been made only by way of example, that numerous changes in the details of implementation of the invention may be made without departing from the spirit and scope of the invention, and that the scope of the invention is limited only by the claims which follow.

What is claimed is:

1. A method of distributing a package of assets to a portable device, comprising:
identifying the portable device;
identifying an asset that correspond to the portable device and the package of assets; and
transferring the asset and a definition of assets that corresponds to the package of assets to the portable device.

2. A method of presenting a package of assets on a portable device, comprising:
providing information for identifying the portable device;
receiving an asset and a definition of assets, wherein the asset corresponds to the portable device; and
presenting the asset according to the definition of assets.

3. The method of claim 2, further comprising transferring the definition of assets and at least a portion of the set of assets to a computer.

4. The method of claim 3, wherein the computer is a personal computer.

5. The method of claim 3, wherein the computer is a game console.

6. The method of claim 2, wherein the asset is one of a master tone, a video ringer, a wallpaper, a music track, an artist biography, lyrics, an image, coupons, an album list, a list of other artists, and a video.

7. The method of claim 2, further comprising providing an interface enabling a user to sign up for additional assets, purchase concert tickets, or enter a contest.

8. A method of presenting a package of assets on a computer, comprising:
receiving from a portable device at the computer the package of assets including a definition of assets;
modifying the package of assets to correspond to the computer; and
presenting an asset indicated in the definition of assets.

9. The method of claim 8, wherein modifying the package of assets comprises receiving the asset at the computer from a server.

10. The method of claim 8, wherein modifying the package of assets comprises receiving the asset at the computer from a database.

11. The method of claim 8, wherein modifying the package of assets comprises selecting the asset as to be presented on the computer when the asset would not be presented on the portable device.

12. The method of claim 8, wherein modifying the package of assets comprises modifying the asset.

13. The method of claim 8, wherein the computer is a personal computer.

14. The method of claim 8, wherein the computer is a game console.

15. A portable device comprising:
an interface; and
a processor coupled to the interface that:
provides information to the interface for identifying the portable device;
receives an asset and a definition of assets, wherein the asset corresponds to the portable device; and
causes the asset to be presented according to the definition of assets.

16. The portable device of claim 15, wherein the processor also causes the definition of assets and at least a portion of the set of assets to be transferred to a computer.

17. The portable device of claim 16, wherein the computer is a personal computer.

18. The portable device of claim 16, wherein the computer is a game console.

19. The portable device of claim 15, wherein the asset is one of a master tone, a video ringer, a wallpaper, a music track, an artist biography, lyrics, an image, coupons, an album list, a list of other artists, and a video.

20. The portable device of claim 15, wherein the processor also causes an interface enabling a user to sign up for additional assets, purchase concert tickets, or enter a contest to be provided.

21. A computer-readable medium containing computer-executable instructions that, when executed by a processor, cause the processor to perform a method for presenting a package of assets on a computer, the method comprising:
receiving from a portable device at the computer the package of assets including a definition of assets;
modifying the package of assets to correspond to the computer; and
presenting an asset indicated in the definition of assets.

22. The medium of claim 21, wherein modifying the package of assets comprises receiving the asset at the computer from a server.

23. The medium of claim 21, wherein modifying the package of assets comprises selecting the asset as to be presented on the computer when the asset would not be presented on the portable device.

24. The medium of claim 21, wherein modifying the package of assets comprises modifying the asset.

25. The medium of claim 21, wherein the computer is a personal computer.
